(19) United States
(12) Patent Application Publication
(10) Pub. No.: US 2011/0108477 A1
(43) Pub. Date: May 12, 2011

(54) Tubular Screen Support and System

(75) Inventor: Aaron C. Hammer, Houston, TX (US)

(73) Assignee: BAKER HUGHES INCORPORATED, Houston, TX (US)

(21) Appl. No.: 12/615,339

(22) Filed: Nov. 10, 2009

(51) Int. Cl. B01D 35/28

(52) U.S. Cl. 210/499

(57) ABSTRACT

A tubular screen support system includes, a screen, a base pipe in substantially coaxial alignment with the screen defining an annular space therebetween, and at least one tubular supportive of the screen relative to the base pipe positionable within the annular space having perimetrically localized variations in a radial dimension thereof.

### BACKGROUND

Tubular fluid flowing systems, such as those used in the hydrocarbon recovery and gas sequestration industries, typically use screens to prevent particulate, such as gravel, for example, that is larger than a selected size, from entering the tubular. Such screens typically include wire wrapped around a support structure that is positioned radially outwardly of a base pipe. The base pipe provides a primary flow channel to or from remote locations, such as a surface in a borehole in an earth formation, for example. In addition to the primary flow channel, the base pipe has strength sufficient to withstand mechanical loads experienced thereby including longitudinal loads due to the weight of the tubular string, for example.

Openings through the base pipe permit fluids to flow therethrough from inside to outside of the base pipe as well as from outside to inside of the base pipe. It is often desirable to selectively open or close the openings at various locations along a length of the base pipe to control where along the base pipe fluid is able to flow through the openings. Since valving to control the plurality of openings can add costs and complexity to a system, it is sometimes desirable to minimize the number of openings and to space them longitudinally relatively far from one another. Large longitudinal distances between adjacent openings necessitate longitudinal flow channels of substantial area in annular spaces between the base pipe and the screen or through the screen itself. Such longitudinal flow channels, however, can be restrictive to flow therethrough. Increases in an annular dimension of these flow channels can increase the cross sectional flow area. However, doing so also weakens the structural support of the screen leaving the screen vulnerable to damage.

Arrangements to alleviate the above drawbacks of such systems would be well received in the art.

### BRIEF DESCRIPTION

Disclosed herein is a tubular screen support system. The system includes, a screen, a base pipe in substantially coaxial alignment with the screen defining an annular space therebetween, and at least one tubular supportive of the screen relative to the base pipe positionable within the annular space having perimetrically localized variations in a radial dimension thereof.

Further disclosed herein is a tubular screen support. The tubular screen support includes at least one tubular positionable in an annular space defined between a base pipe and a screen having radial dimensions that vary perimetrically, and the at least one tubular is configured to provide structural support to the screen relative to the base pipe.

### BRIEF DESCRIPTION OF THE DRAWINGS

The following descriptions should not be considered limiting in any way. With reference to the accompanying drawings, like elements are numbered alike:

FIG. 1 depicts a partial cross sectional perspective view of a tubular screen support disclosed herein;

FIG. 2 depicts a partial cross sectional perspective view of an alternate tubular screen support disclosed herein having a tubular with varying wall thickness;

FIG. 3 depicts a partial cross sectional perspective view of an alternate tubular screen support disclosed herein having elongated members integrated into a tubular wall;

FIG. 4 depicts a partial cross sectional perspective view of an alternate tubular screen support disclosed herein having a perimetrically corrugated tubular;

FIG. 5 depicts a cross sectional view of an alternate tubular screen support disclosed herein having multiple tubulars; and

FIG. 6 depicts a cross sectional view of an alternate tubular screen support disclosed herein having multiple corrugated tubulars.

### DETAILED DESCRIPTION

A detailed description of one or more embodiments of the disclosed apparatus and method are presented herein by way of exemplification and not limitation with reference to the Figures.

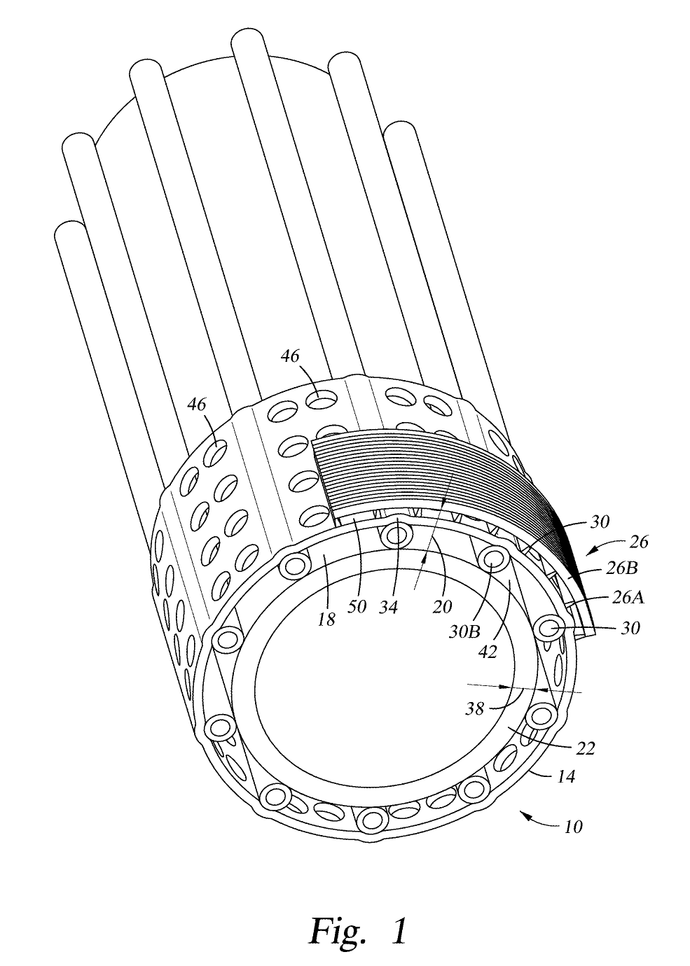

Referring to FIG. 1, an embodiment of a tubular screen support disclosed herein is illustrated generally at 10. The tubular screen support 10 includes, a tubular 14 configured to be positioned in an annular space 18, of annular dimension 20, defined between a base pipe 22 and a screen 26. The screen 26, in this embodiment includes ribs 26A positioned radially outwardly of the tubular 14, and wire wrap 26B, wrapped around the ribs 26A. A plurality of elongated members 30, illustrated in this embodiment as tubes, are positioned radially between the base pipe 22 and the tubular 14 and structurally support the tubular 14 relative to the base pipe 22. Attachment of the tubular 14, the base pipe 22, the screen 26 and the elongated members 30, to one another, can be by any of a variety of means such as by welding, brazing, press fitting, heat shrinking, and adhesive bonding, for example.

The tubular 14 has perimetrically localized variations 34 in radial dimensions thereof. In this embodiment, the localized variations 34 are dimensioned to be engaged with the elongated members 30B. The elongated members 30B are rotationally offset in comparison to the wire wrap 26B. This rotational offset allows the annular dimension 20 to be smaller than it would be if the tubular 14 had inner and outer radial surfaces that were cylindrical and did not include the perimetrically localized variations 34 (for systems using similarly dimensioned elongated members 30 and ribs 26A). By keeping the annular dimension 20 small the base pipe 22 can have a larger inside diameter than it otherwise would thereby minimizing restriction to flow therethrough. Additionally, a wall thickness 38 of the base pipe 22 can be greater than it otherwise could be, thereby providing greater structural strength. Additional structural support for the base pipe 22 can be provided by the attachment of the elongated members 30 to the base pipe.

A plurality of flow channels 42 and 50 (shown herein as being longitudinal although helical and other geometries are contemplated), are defined by the annular space 18 between adjacent elongated members 30 and ribs 26A, respectively. A cross sectional area of the flow channels 42 can be set as needed based on the anticipated flow rates and lengths of the flow channels 42 to prevent undesirable restriction to fluid flow therethrough, without detrimentally affecting the structural support to the screen 26. This is due to the fact that the tubular 14 through the ribs 26A provides the structural support for the wire wrap 26B. Additionally, the localized variations 34 in the tubular 14 will contribute to the stiffness and strength of the tubular 14 thereby allowing greater structural support to the screen 26 without a need for additional wall thickness of the tubular 14.

A plurality of ports 46 through the tubular 14 fluidically connect the flow channels 42 to the flow channels 50 defined between the screen 26 and the tubular 14. The cross sectional flow area through the ports 46 can be made much larger than the flow area of the flow channels 42 and 50. Consequently, there is no concern in creating a restriction through the ports 46 if the ports 46 are specifically positioned to avoid being aligned with either of the elongated members 30 or the ribs 26A.

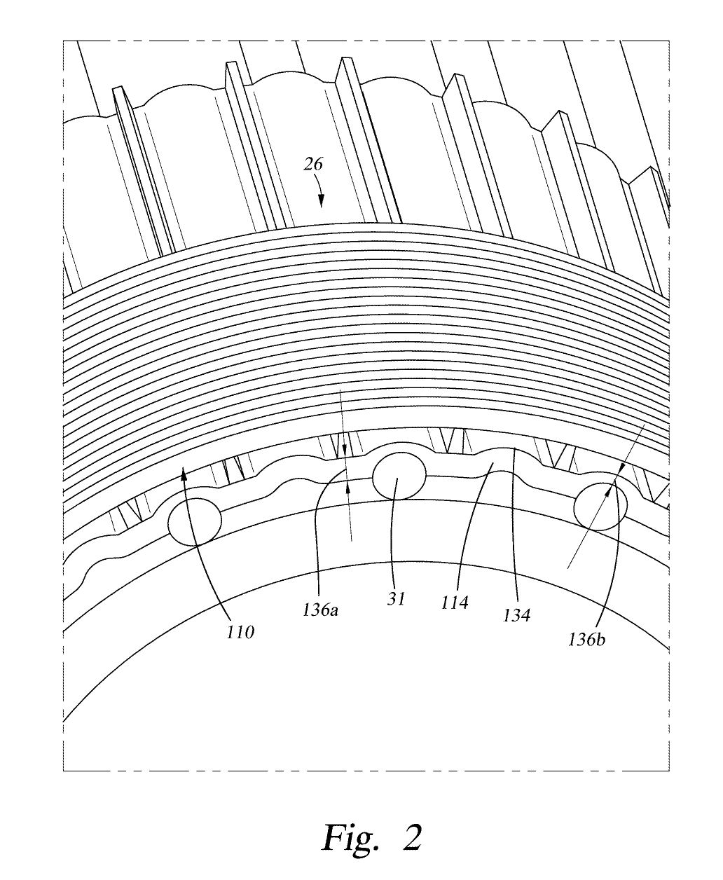

Referring to FIG. 2, an alternate embodiment of a tubular screen support 110 disclosed herein is illustrated. The support 110 has many similarities to that of support 10 and as such only the differences between the two will be described and depicted with unique reference characters. A tubular 114 of the support 110 includes perimetrically localized variations 134 in radial dimensions thereof that are independent of locations of the elongated members 31. These additional localized variations 134 provide stiffening to the tubular 114 such that the tubular 114 can structurally support the screen 26 while minimizing a wall thickness 136A of the tubular 114.

Additionally, wall thickness of the tubular 114 varies, with a smaller wall thickness 136B being perimetrically aligned with the elongated members 31. This variation in wall thickness of the tubular 114 further permits reductions in the annular dimension 20 without sacrificing strength. In fact, the strength of the tubular 114 in the portion with the smaller wall thickness 136B, can actually be made to be stronger than areas with the standard wall thickness 136A by attachment of the tubular 114 to the elongated member 31.

It should be noted that the elongated member 31, illustrated in this embodiment, differs from the elongated member 30 in that it is solid as opposed to hollow. Many variations in the elongated members 30, 31 are contemplated, such as, changes in size, geometry and material to thereby form rods, tubes, ribs and bars, for example. The elongated members 30, 31 may be a transmission line, such as a sensing line, a control line, an optical fiber or electrical line, for example.

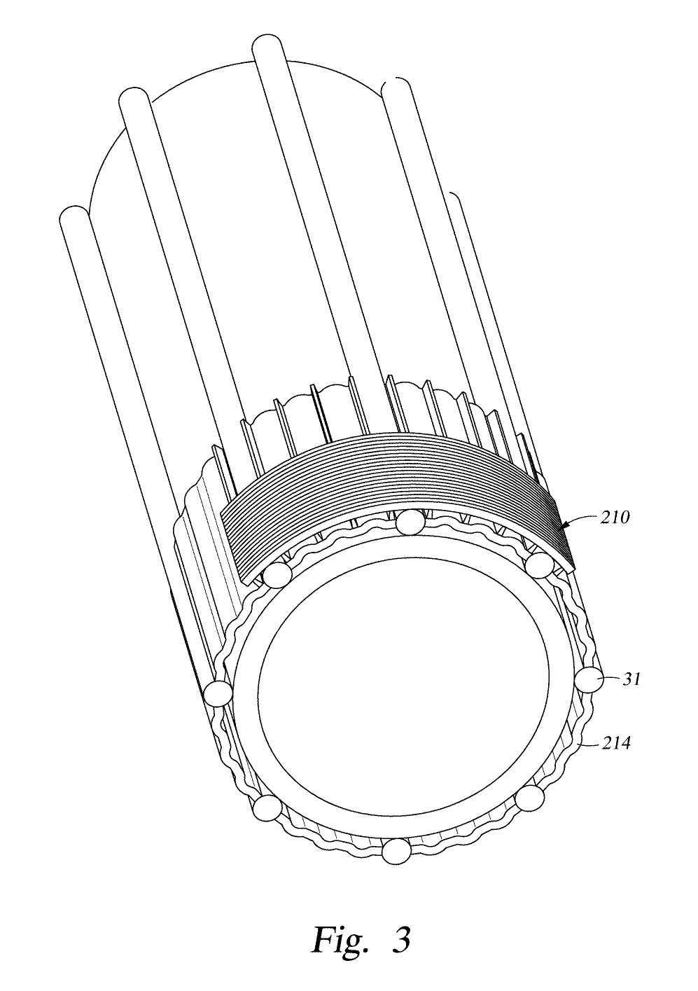

Referring to FIG. 3, another embodiment of a tubular screen support 210 disclosed herein is illustrated. The support 210 differs from the supports 110 and 10 in that a portion of a tubular 214 is constructed of the elongated member 31 directly. An attachment method of the elongated member 31 to the balance of the tubular 214 may preferably be by welding to assure structural stability. Elongated member 31 could also be replaced with the solid elongated member 30 discussed above.

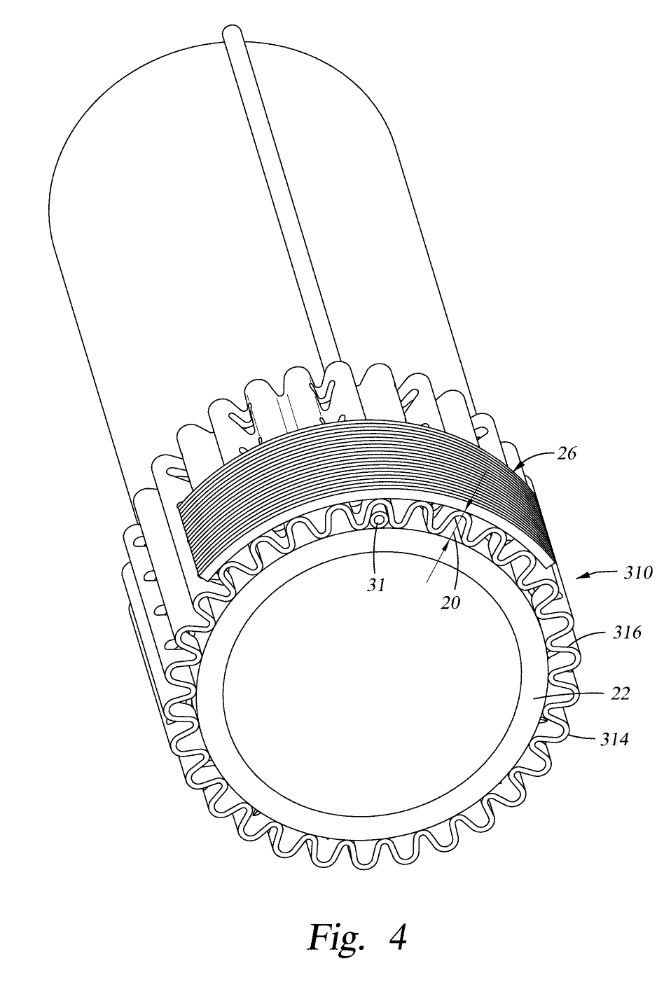

Referring to FIG. 4, an alternate embodiment of a tubular screen support 310 is depicted. The support 310 differs from the above embodiments in that a tubular 314 has perimetrical corrugations 316 that span the entire annular dimension 20. As such, the rib 26A is not necessary to the direct structural support of the wire wrap 26B but could add to the strength when attached to one or more of the tubular 314, the wire wrap 26B and the base pipe 22.

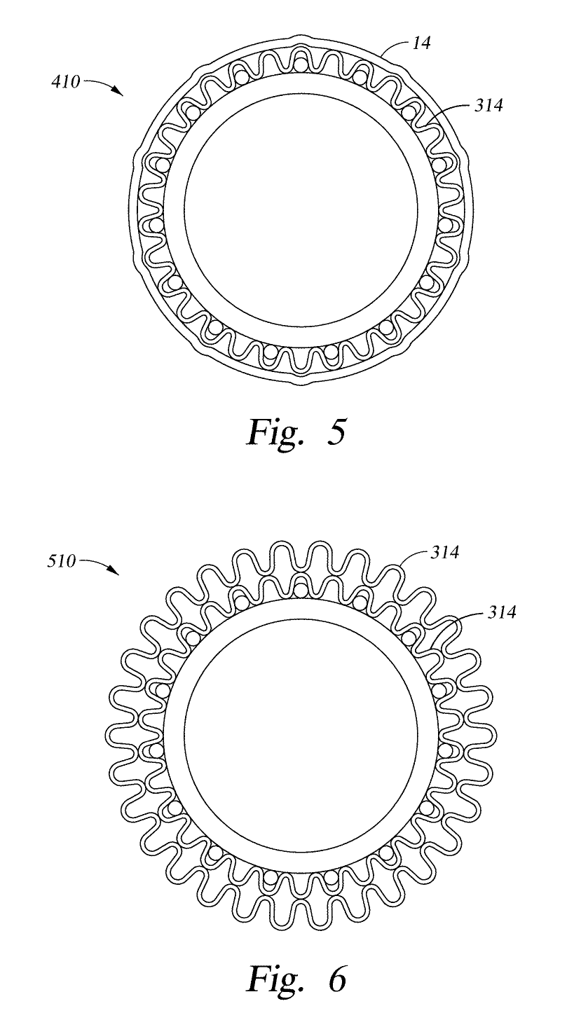

Referring to FIGS. 5 and 6, alternate embodiments of tubular screen supports 410 and 510 are illustrated. The supports 410 and 510 differ from the above-described embodiments by combining more than one of the tubulars 14 and 314 within a single assembly to span the annular dimension 20.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A tubular screen support system comprising:
a screen;
a base pipe in substantially coaxial alignment with the screen defining an annular space therebetween; and
at least one tubular supportive of the screen relative to the base pipe positionable within the annular space having perimetrically localized variations in a radial dimension thereof.

2. The tubular screen support system of claim 1, further comprising at least one elongated member bridging an annular gap between the at least one tubular and the base pipe.

3. The tubular screen support system of claim 2, wherein the at least one elongated member is at least one of a group consisting of, rods, tubes, ribs and bars.

4. The tubular screen support system of claim 2, wherein the at least one elongated member is a transmission line.

5. The tubular screen support system of claim 4, wherein the transmission line is one of a sensing line, a control line, an optical fiber and an electrical line.

6. The tubular screen support system of claim 2, wherein walls of the at least one tubular are thinner at locations in contact with the at least one elongated member.

7. The tubular screen support system of claim 2, wherein portions of walls of the at least one tubular are formed by the at least one elongated member.

8. The tubular screen support system of claim 1, wherein walls of the at least one tubular have at least one port therethrough.

9. The tubular screen support system of claim 1, wherein the screen includes at least one rib and a wire wrap and an annular gap defined between the wire wrap and the at least one tubular is spanned by the at least one rib.

10. The tubular screen support system of claim 1, wherein a wall of the at least one tubular varies in thickness.

11. The tubular screen support system of claim 1, wherein the tubular screen support system is configured such that an annular dimension between the base pipe and the screen is smaller than had the at least one tubular not included the perimetrically localized variations in a dimension thereof.

12. The tubular screen support system of claim 1, wherein larger cross sectional area flow channels are formed between the at least one tubular and the base pipe than would be possible in the annular space defined by a specific dimensional set of a base pipe and a screen had the perimetrically localized variations in radial dimension not been present.

13. The tubular screen support system of claim 1, wherein the at least one tubular is configured to provide structural support to the base pipe by attachment thereto.

14. The tubular screen support system of claim 1, wherein the at least one tubular spans the annular space.

15. A tubular screen support comprising at least one tubular positionable in an annular space defined between a base pipe and a screen having perimetrically localized variations in radial dimensions thereof, the at least one tubular being configured to provide structural support to the screen relative to the base pipe.

16. The tubular screen support of claim 15, wherein the perimetrically localized variations in radial dimensions of the at least one tubular allow the at least one tubular to span the annular space.

17. The tubular screen support of claim 15, wherein the at least one tubular has a plurality of ports therethrough.

18. The tubular screen support of claim 15, wherein the at least one tubular provides structural support to the base pipe.

19. The tubular screen support of claim 15, wherein the at least one tubular is attachable to at least one of the base pipe and the screen.

20. The tubular screen support of claim 19, wherein attachment of the at least one tubular is by at least one of welding, brazing, press fitting, heat shrinking and adhesive bonding.
